(19) United States
(12) Patent Application Publication
(10) Pub. No.: US 2026/0181422 A1
(43) Pub. Date: Jun. 25, 2026

(54) COMMUNICATION METHOD AND DEVICE EMPLOYING ARTIFICIAL INTELLIGENCE (AI) MODEL, AND STORAGE MEDIUM

(71) Applicant: Beijing Xiaomi Mobile Software Co., Ltd., Beijing (CN)

(72) Inventors: Qin MU, Beijing (CN); Xing YANG, Beijing (CN)

(73) Assignee: Beijing Xiaomi Mobile Software Co., Ltd., Beijing (CN)

(21) Appl. No.: 19/125,186

(22) PCT Filed: Nov. 6, 2022
(86) PCT No.: PCT/CN2022/130179

§ 371 Date: Apr. 28, 2025

(51) Int. Cl. H04W 24/02

(52) U.S. Cl. CPC H04W 24/02

(57) ABSTRACT

The present disclosure relates to a communication method based on an Artificial Intelligence (AI) model. The method is applied to an AI provider node, and the method includes: sending the AI model to an AI inference node.

### CROSS REFERENCE TO RELATED APPLICATION

The present application is a U.S. National Stage of International Application No. PCT/CN 2022/130179, filed on Nov. 6, 2022, the contents of which are incorporated herein by reference in its entirety.

### TECHNICAL FIELD

The present disclosure relates to the communication technical field, and in particular to a communication method and apparatus based on an Artificial Intelligence (AI) model, and a storage medium.

### BACKGROUND

In recent years, Artificial Intelligence (AI) technologies have made continuous breakthroughs in many fields. While integrating knowledge from different disciplines, AI technologies have also provided new directions and methods for the developments of different disciplines.

### SUMMARY

According to a first aspect of an embodiment of the present disclosure, there is provided a communication method based on an Artificial Intelligence (AI) model. The method includes:
sending the AI model to an AI inference node.

According to a second aspect of an embodiment of the present disclosure, there is provided a communication method based on an Artificial Intelligence (AI) model. The method includes:
receiving the AI model sent by an AI provider node.

According to a third aspect of an embodiment of the present disclosure, there is provided a communication method based on an Artificial Intelligence (AI) model. The method includes:
receiving the AI model sent by an AI provider node; and sending the AI model to an AI inference node.

According to a further aspect of an embodiment of the present disclosure, there is provided a communication apparatus, including:
a processor; and
a memory configured to store instructions executable by the processor;
wherein the processor is configured to perform the method according to any one of implementations in the above first aspect.

According to a further aspect of an embodiment of the present disclosure, there is provided a communication apparatus, including:
a processor;
a memory configured to storing instructions executable by the processor;
wherein the processor is configured to perform the method according to any one of implementations in the above second aspect.

According to a ninth aspect of an embodiment of the present disclosure, there is provided a communication apparatus, including:
a processor; and
a memory configured to store instructions executable by the processor;
wherein the processor is configured to perform the method according to any one of implementations in the above third aspect.

According to a tenth aspect of an embodiment of the present disclosure, there is provided a storage medium. Instructions are stored in the storage medium, and when the instructions in the storage medium are executed by a processor, the processor is caused to perform the communication method according to any one of implementations in the first aspect.

According to an eleventh aspect of an embodiment of the present disclosure, there is provided a storage medium. Instructions are stored in the storage medium, and when the instructions in the storage medium are executed by a processor, the processor is caused to perform the communication method according to any one of implementations in the second aspect.

According to a twelfth aspect of an embodiment of the present disclosure, there is provided a storage medium. Instructions are stored in the storage medium, and when the instructions in the storage medium are executed by a processor, the processor is caused to perform the communication method according to any one of implementations in the third aspect.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of the description, illustrate embodiments consistent with the present disclosure and, together with the description, serve to explain the principles of the present disclosure.

FIG. 1 is a schematic diagram of a wireless communication system.

FIG. 2 is a flowchart of a communication method based on an artificial intelligence model according to an example embodiment.

FIG. 3 is a flowchart of another method based on an artificial intelligence model according to an example embodiment.

FIG. 4 is a flowchart of yet another method based on an artificial intelligence model according to an example embodiment.

FIG. 5 is a flowchart of a method for sending an AI model to a terminal according to an example embodiment.

FIG. 6 is a flowchart of another method for sending an AI model to a terminal according to an example embodiment.

FIG. 7 is a flowchart of yet another method based on an artificial intelligence model according to an example embodiment.

FIG. 8 is a flowchart of a method for sending an AI model to a radio access network device according to an example embodiment.

FIG. 9 is a flowchart of another method for sending an AI model to a radio access network device according to an example embodiment.

FIG. 10 is a flowchart of a method based on an artificial intelligence model according to an example embodiment.

FIG. 11 is a flowchart of another method based on an artificial intelligence model according to an example embodiment.

FIG. 12 is a flowchart of a method for receiving an AI model sent by a radio access network device according to an example embodiment.

FIG. 13 is a flowchart of another method for receiving an AI model sent by a radio access network device according to an example embodiment.

FIG. 14 is a flowchart of yet another method based on an artificial intelligence model according to an example embodiment.

FIG. 15 is a flowchart of a method for a radio access network device to perform an inference task according to an example embodiment.

FIG. 16 is a flowchart of a method for receiving an AI model sent by a terminal according to an example embodiment.

FIG. 17 is a flowchart of another method for receiving an AI model sent by a terminal according to an example embodiment.

FIG. 18 is a flowchart of a method for an AI inference node to perform an inference task based on an AI model according to an example embodiment.

FIG. 19 is a flowchart of a method based on an artificial intelligence model according to an example embodiment.

FIG. 20 is a flowchart of another method based on an artificial intelligence model according to an example embodiment.

FIG. 21 is a flowchart of yet another method based on an artificial intelligence model according to an example embodiment.

FIG. 22 is a schematic diagram of a radio access network device transferring an AI model directly to a terminal.

FIG. 23 is a schematic diagram of a terminal transferring an AI model directly to a radio access network device.

FIG. 24 is a schematic diagram of indirect AI model transfer between a radio access network device and a terminal through a core network device.

FIG. 25 is a schematic diagram of another method for indirect AI model transfer between a radio access network device and a terminal through a core network device.

FIG. 26 is a block diagram of a communication apparatus based on an Artificial Intelligence (AI) model according to an example embodiment.

FIG. 27 is a block diagram of a communication apparatus based on an Artificial Intelligence (AI) model according to an example embodiment.

FIG. 28 is a block diagram of a communication apparatus based on an Artificial Intelligence (AI) model according to an example embodiment.

FIG. 29 is a block diagram of an apparatus for a communication based on an Artificial Intelligence (AI) model according to an example embodiment.

FIG. 30 is a block diagram of an apparatus for a communication based on an Artificial Intelligence (AI) model according to an example embodiment.

### DETAILED DESCRIPTION

Here, example embodiments will be described in detail, examples of which are shown in the accompanying drawings. When the following description refers to the drawings, the same numbers in different drawings represent the same or similar elements unless otherwise indicated. The implementations described in the following example embodiments do not represent all implementations consistent with the present disclosure.

It is understandable that a wireless communication system shown in FIG. 1 is only for schematic illustration, and the wireless communication system may also include other network device(s), such as a core network device, a wireless relay device, and a wireless backhaul device and so on, which are not shown in FIG. 1. The embodiments of the present disclosure do not limit the number of network device(s) and terminal(s) included in the wireless communication system.

It can be further understood that the wireless communication system of the embodiment of the present disclosure is a network that provides a wireless communication function. The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier Frequency Division Multiple Access (Single Carrier FDMA, SC-FDMA), Carrier Sense Multiple Access with Collision Avoidance. According to factors such as the capacity, rate, or delay of different networks, the networks may be divided into a 2G (English: generation) network, a 3G network, a 4G network or a future evolved network, such as 5G network, the 5G network may also be called a new radio network (New Radio, NR). For the convenience of description, the present disclosure sometimes refers to the wireless communication network as a network.

Furthermore, a radio access network device involved in the present disclosure may be: a base station, an evolved base station (evolved node B, base station), a home base station, an Access Point (AP) in a wireless fidelity (WIFI) system, a wireless relay node, a wireless backhaul node, a Transmission Point (TP) or a Transmission and Reception Point (TRP), etc., or the radio access network device may also be a gNB in the NR system, or may also be a component or part constituting a base station. It should be understood that the specific technology and specific device form adopted by the network device are not limited in the embodiments of the present disclosure. In the present disclosure, the network device may provide communication coverage for a specific geographical area and may communicate with terminal(s) located in the coverage area (cell). In addition, when the system is a vehicle-to-everything (V2X) communication system, the network device may also be a vehicle-mounted device.

Furthermore, a terminal involved in the present disclosure may also be referred to as a terminal device, User Equipment (UE), a Mobile Station (MS), a Mobile Terminal (MT), etc., and the terminal is a device that provides voice and/or data connectivity to a user. For example, the terminal may be a handheld device with a wireless connection function, or a vehicle-mounted device, etc. At present, some examples of the terminal are: a smart phone (Mobile Phone), Customer Premise Equipment (CPE), a Pocket Personal Computer (PPC), a handheld computer, a Personal Digital Assistant (PDA), a laptop computer, a tablet computer, a wearable device, or a vehicle-mounted device, etc. In addition, when the system is a vehicle-to-everything (V2X) communication system, the terminal device may also be a vehicle-mounted device. It should be understood that the embodiments of the present disclosure do not limit the specific technology and specific device form adopted by the terminal.

At present, in related art, AI's use cases in the researches on wireless AI technology may include, for example: AI-based Channel State Information (CSI) enhancement, AI-based beam association, AI-based positioning, etc.

In related art, there are multiple types of communication devices such as a core network device, a radio access network device, and a terminal in a communication system. Communication(s) between different communication devices based on an AI model is(are) supported in the communication system. However, the communication based on the AI model includes an AI provider node and an AI inference node. When the AI provider node and the AI inference node are located at different communication devices, there is a transfer need for transferring the AI model from one communication device to another communication device.

There are two very important stages involved in an AI activity (operation). For example, the first stage may be a training stage of an AI model, that is, a stage of obtaining the AI model. The second stage may be a deployment stage of the AI model, that is, an inference and application stage of the AI model. For the deployment stage, it is needed to pre-configure an AI provider node and an AI inference node in a communication device. The AI provider node refers to a node that provides the trained AI model, and the AI inference node refers to a node that performs an inference task based on the AI model. Since the same communication system often involves multiple communication devices and the communication(s) of the communication devices based on the AI model often involves(involve) multiple processing nodes, the configuration method of the processing nodes are diverse for multiple communication devices involved in the communication system. For example, the AI provider node and the AI inference node may be configured on the same communication device. Alternatively, the AI provider node and the AI inference node are configured on different communication devices.

In a scenario where the AI provider node and the AI inference node are located at different communication devices, a communication device carrying the AI inference node needs to be provided with the AI model by a communication device carrying the AI provider node. Therefore, in the related art, there is a transfer need for transferring an AI model from one communication device to another communication device.

In view of the above, the present disclosure provides a method based on an artificial intelligence model. The method aims to send an AI model from an AI provider node to an AI inference node in the scenario where the AI inference node and the AI provider node are located at different devices, so as to make the AI inference node perform an inference task according to the received AI model.

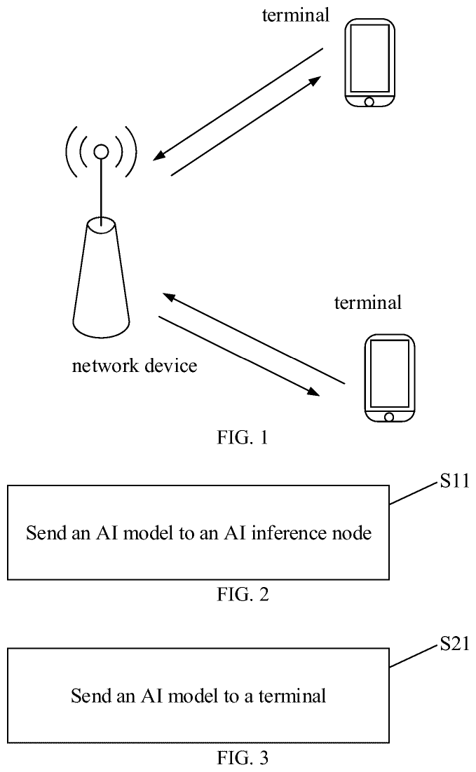

FIG. 2 is a flowchart of a method based on an artificial intelligence model according to an example embodiment. As shown in FIG. 2, the method is applied in a radio access network device and includes the following step.

In step S11, an AI model is sent to an AI inference node.

In the embodiment of the present disclosure, the AI inference node and the AI provider node may be located at the same communication device or different communication devices. In a case where the AI inference node and the AI provider node are located at different communication devices, the AI provider node may send the AI model to the AI inference node to make the AI inference node obtain the AI model and perform an inference task based on the AI model.

Typically, an AI model has multiple network layers, each layer includes multiple computing elements, and computing elements of each layer have a certain connection relationship with computing elements of other layer(s), and the connection relationship is configured with a corresponding weight. In an embodiment of the present disclosure, a complete AI model or a partial AI model may be transferred between the AI inference node and the AI provider node. The partial AI model may be understood as the remaining part of the AI model after discarding at least one of:
one or more network layers, one or more computing elements, one or more connection relationships, and one or more configuration weights. For example, only a part of the network layers of the AI model or a part of the computing elements may be transferred, or only weight(s) connecting respective elements may be transferred.

In the embodiments of the present disclosure, the AI provider node and the AI inference node are located at different devices. For example, the AI provider node may be located at a radio access network device, and the AI inference node may be located at a terminal; or, the AI provider node may be located at the terminal, and the AI inference node may be located at the radio access network device. In a case where the AI provider node is located at the radio access network device and the AI inference node is located at the terminal, the AI model may be transferred in the following manner.

FIG. 3 is a flowchart of another method based on an artificial intelligence model according to an example embodiment. As shown in FIG. 3, the method includes the following step.

In step S21, an AI model is sent to a terminal.

In the method provided by the embodiment of the present disclosure, in the case where the AI provider node is located at the radio access network device and the AI inference node is located at the terminal, the AI model is sent from the radio access network device to the terminal.

For example, in the case where the AI provider node is located at the radio access network device and the AI inference node is located at the terminal, the radio access network device side may determine the AI model required for the terminal to perform an inference task. Further, the radio access network device may send the determined AI model to the terminal.

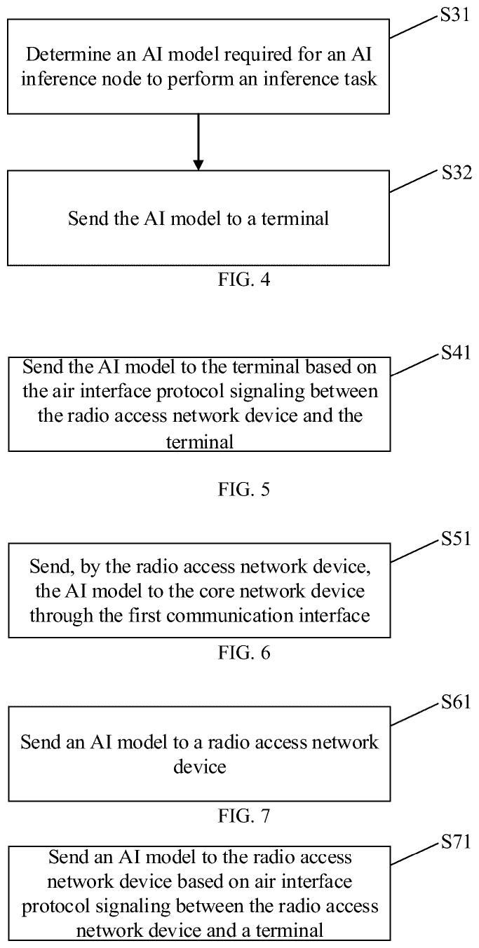

FIG. 4 is a flowchart of another method based on an artificial intelligence model according to an example embodiment. As shown in FIG. 4, the method includes the following steps.

In step S31, an AI model required for an AI inference node to perform an inference task is determined.

In step S32, the AI model is sent to a terminal.

For example, in the case where the AI provider node is located at the radio access network device and the AI inference node is located at the terminal, two feasible AI model transfer methods are provided below.

In an embodiment of the present disclosure, air interface protocol signaling is pre-configured between the radio access network device and the terminal. In a feasible implementation, the direct AI model transfer may be achieved through the air interface protocol signaling between the radio access network device and the terminal.

FIG. 5 is a flowchart of a method for sending an AI model to a terminal according to an example embodiment. As shown in FIG. 5, the method includes the following step.

In step S41, the AI model is sent to the terminal based on the air interface protocol signaling between the radio access network device and the terminal.

In the method provided in the embodiment of the present disclosure, the radio access network device directly transfers the AI model to the terminal according to the air interface protocol signaling between the radio access network device and the terminal.

In an embodiment of the present disclosure, the air interface protocol signaling includes at least one of: physical layer signaling, logical access layer (Medium Access Control, MAC) signaling, Radio Resource Control (RRC) signaling or air interface user plane signaling.

In an embodiment of the present disclosure, in addition to the radio access network device and the terminal, the communication system may also include a core network device, for example. In another feasible implementation, the AI model sent by the AI provider node may be forwarded to the AI inference node by the core network device to realize indirect AI model transfer. In the case where the AI provider node is located at the radio access network device and the AI inference node is located at the terminal, the radio access network device may send the AI model to the core network device, and then the core network device may forward the AI model to the terminal. For the convenience of description below, the present disclosure refers to a communication interface between the radio access network device and the core network device as a first communication interface, and a communication interface between the core network device and the terminal as a second communication interface.

FIG. 6 is a flowchart of another method for sending an AI model to a terminal according to an example embodiment. As shown in FIG. 6, the method includes the following step.

In step S51, the radio access network device sends the AI model to the core network device through the first communication interface.

In the embodiment of the present disclosure, in a case where the radio access network device sends the AI model to the core network device through the first communication interface, the AI model can be sent to the terminal by the core network device through the second communication interface. At this point, the AI model transfer from the radio access network device to the terminal can be completed.

The core network device involved in the above embodiments may be, for example, an Operation Administration and Maintenance (OAM) device, or a Network Data Analytics Function (NWDAF) device. In addition, the core network device generally also includes an Access and Mobility management Function (AMF) device, as well as a User Plane Function (UPF) device. Accordingly, the first communication interface between the radio access network device and the core network device may, for example, include a dedicated communication interface between the radio access network device and the UPF, or a dedicated communication interface between the radio access network device and the AMF. As a feasible implementation, the AI model may be sent by the OAM or the NWDAF to the AMF or the UPF, so as to complete the AI model transfer with the radio access network through the AMF or the UPF.

In an implementation, the AI model transfer between the radio access network device and the core network device may be performed through a dedicated communication interface between the radio access network device and the AMF. On this basis, the core network device accordingly uses a Non-Access Stratum (NAS) signaling interface to perform the AI model transfer with the terminal.

In another implementation, the AI model transfer between the radio access network device and the core network device may be performed through a dedicated communication interface between the radio access network device and the UPF. On this basis, the core network device accordingly uses a User Plane (UP) protocol interface to perform the AI model transfer with the terminal.

In the above embodiments, for the case where the AI provider node is located at the radio access network device and the AI inference node is located at the terminal, feasible ways of AI model transfer are provided.

In addition, as another possible case, the AI provider node may be located at the terminal and the AI inference node may be located at the radio access network device. In this case, the AI model is sent by the terminal and is received by the radio access network device.

FIG. 7 is a flowchart of yet another method based on an artificial intelligence model according to an example embodiment. As shown in FIG. 7, the method includes the following step.

In step S61, an AI model is sent to a radio access network device.

In the method provided by the embodiment of the present disclosure, in the case where the AI provider node is located at the terminal and the AI inference node is located at the radio access network device, the radio access network device which performs the inference task can smoothly receive the AI model, so that the radio access network device can complete the inference task based on the AI model.

In a feasible implementation, direct AI model transfer may be achieved through air interface protocol signaling between the radio access network device and the terminal.

FIG. 8 is a flowchart of a method for sending an AI model to a radio access network device according to an example embodiment. As shown in FIG. 8, the method includes the following steps.

In step S71, an AI model is sent to the radio access network device based on air interface protocol signaling between the radio access network device and a terminal.

According to the method provided in the embodiment of the present disclosure, the terminal directly transfers the AI model to the radio access network device according to the air interface protocol signaling between the radio access network device and the terminal.

In an embodiment of the present disclosure, the air interface protocol signaling includes at least one of: physical layer signaling, logical access layer (MAC) signaling, Radio Resource Control (RRC) signaling, or air interface user plane signaling.

In another feasible implementation, the AI model sent by the terminal may be forwarded to the radio access network device through a core network device to realize indirect AI model transfer. For the convenience of description, a communication interface between the terminal and the core network device is referred to as a first communication interface, and a communication interface between the core network device and the radio access network device is referred to as a second communication interface.

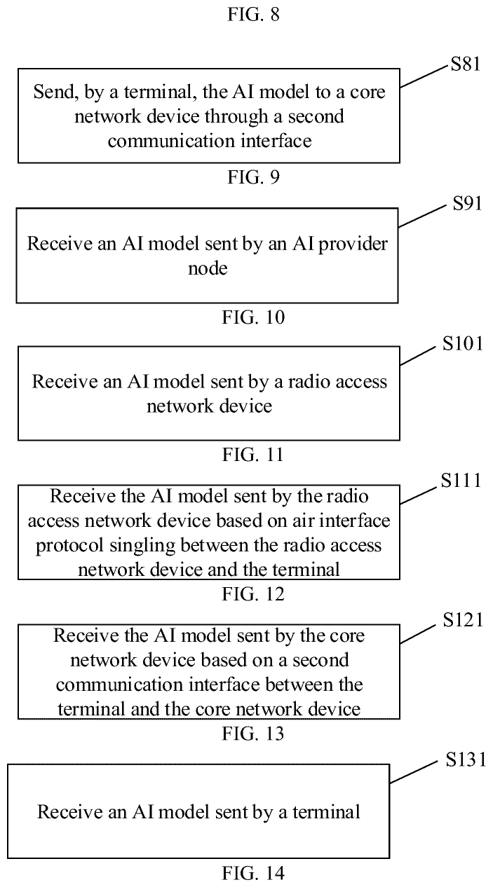

FIG. 9 is a flowchart of another method for sending an AI model to a radio access network device according to an example embodiment. As shown in FIG. 9, the method includes the following step.

In step S81, a terminal sends the AI model to a core network device through a second communication interface.

In the embodiment of the present disclosure, the terminal may send the AI model to the core network device through the second communication interface. Correspondingly, the AI model sent to the core network device may be further sent to the radio access network device by the core network device through the first communication interface. At this point, the AI model transfer from the terminal to the radio access network device can be completed.

The core network device involved in the above embodiments may be, for example, an Operation Administration and Maintenance (OAM) device, or a Network Data Analytics Function (NWDAF) device. In addition, the core network device generally also includes an Access and Mobility management Function (AMF) device, as well as a User Plane Function (UPF) device. Accordingly, the first communication interface between the radio access network device and the core network device may, for example, include a dedicated communication interface between the radio access network device and the UPF, or a dedicated communication interface between the radio access network device and the AMF. As a feasible implementation, the AI model may be sent by the OAM or the NWDAF to the AMF or the UPF, so as to complete the AI model transfer with the radio access network through the AMF or the UPF.

In an implementation, the AI model transfer between the radio access network device and the core network device may be performed through a dedicated communication interface between the radio access network device and the AMF. On this basis, the core network device accordingly uses a NAS signaling interface to perform the AI model transfer with the terminal.

In another implementation, the AI model transfer between the radio access network device and the core network device may be performed through a dedicated communication interface between the radio access network device and the UPF. On this basis, the core network device accordingly uses the upload UP protocol interface to perform the AI model transfer with the terminal.

Based on the same concept, the present disclosure provides another communication method based on an AI model. The method is applied to an AI inference node which is used to interact with the AI provider node involved in any one of the above embodiments to complete the transfer of the AI model. If there are any unclear points in the following embodiments, reference may be made to any one of the above embodiments. Similarly, if there are any unclear points in the above embodiments, reference may be made to any one of the following embodiments.

FIG. 10 is a flowchart of a method based on an artificial intelligence model according to an example embodiment. As shown in FIG. 10, the method includes the following step.

In step S91, an AI model sent by an AI provider node is received.

In the method provided by the implementation of the present disclosure, the AI model can be transferred between the AI provider node and the AI inference node. On the basis that the AI provider node sends the AI model to the AI inference node, the AI inference node can perform an inference task through the AI model.

In an embodiment of the present disclosure, the AI provider node and the AI inference node are located at different devices. Taking a radio access network device and a terminal as an example, for example, the AI provider node may be located at the radio access network device and the AI inference node may be located at the terminal; or, the AI provider node may be located at the terminal and the AI inference node may be located at the radio access network device. For the case where the AI provider node is located at the radio access network device and the AI inference node is located at the terminal, the AI model may be transferred in the following manner.

FIG. 11 is a flowchart of another method based on an artificial intelligence model according to an example embodiment. As shown in FIG. 11, the method includes the following step.

In step S101, an AI model sent by a radio access network device is received.

In the method provided by the embodiment of the present disclosure, for the case where the AI provider node is located at the radio access network device and the AI inference node is located at the terminal, the AI model is sent from the radio access network device to the terminal. For this case, two feasible AI model transfer methods are provided below.

In an embodiment of the present disclosure, air interface protocol signaling is pre-configured between the radio access network device and the terminal. In a feasible implementation, direct transfer of the AI model may be achieved through the air interface protocol signaling between the radio access network device and the terminal.

FIG. 12 is a flowchart of a method for receiving an AI model sent by a radio access network device according to an example embodiment. As shown in FIG. 12, the method includes the following step.

In step S111, based on the air interface protocol signaling between the radio access network device and the terminal, the AI model sent by the radio access network device is received.

According to the method provided by the embodiment of the present disclosure, the terminal receives the AI model sent by the radio access network device according to the air interface protocol signaling between the radio access network device and the terminal.

In an embodiment of the present disclosure, the air interface protocol signaling includes at least one of: physical layer signaling, logical access layer MAC signaling, Radio Resource Control (RRC) signaling, or air interface user plane signaling.

In an embodiment of the present disclosure, in addition to the radio access network device and the terminal, the communication system may also include a core network device, for example. In another feasible implementation, the AI model sent by the radio access network device may be forwarded to the terminal through the core network device to achieve indirect AI model transfer.

FIG. 13 is a flowchart of another method for receiving an AI model sent by a radio access network device according to an example embodiment. As shown in FIG. 13, the method includes the following step.

In step S121, the AI model sent by a core network device based on a second communication interface between the terminal and the core network device is received.

The AI model is sent by the radio access network device to the core network device based on a first communication interface between the radio access network device and the core network device.

In the method provided by the embodiment of the present disclosure, the AI model sent by the radio access network device can be received by the core network device, and the core network device forwards the received AI model to the terminal.

In an embodiment of the present disclosure, the core network device includes an AMF and a UPF. Accordingly, the first communication interface between the radio access network device and the core network device may include, for example, a dedicated communication interface between the radio access network device and the UPF, or a dedicated communication interface between the radio access network device and the AMF.

In an implementation, the AI model transfer between the radio access network device and the core network device may be performed through a dedicated communication interface between the radio access network device and the AMF. On this basis, the core network device accordingly uses a NAS signaling interface to perform AI model transfer with the terminal.

In another implementation, the AI model transfer between the radio access network device and the core network device may be performed through a dedicated communication interface between the radio access network device and the UPF. On this basis, the core network device accordingly uses an upload UP protocol interface to perform the AI model transfer with the terminal.

In the above embodiments, for the case where the AI provider node is located at the radio access network device and the AI inference node is located at the terminal, feasible ways for AI model transfer are provided.

In addition, as another possible case, the AI provider node may be located at the terminal and the AI inference node may be located at the radio access network device. In this case, the AI model is sent by the terminal and received by the radio access network device.

FIG. 14 is a flowchart of yet another method based on an artificial intelligence model according to an example embodiment. As shown in FIG. 14, the method includes the following step.

In step S131, an AI model sent by a terminal is received.

In the method provided by the embodiment of the present disclosure, for the case where the AI provider node is located at the terminal and the AI inference node is located at the radio access network device, the terminal sends the AI model to the radio access network device, so as to make the radio access network device receive the AI model to complete an inference task based on the AI model.

For example, in a case where the radio access network device receives the AI model sent by the terminal, the radio access network device can perform the inference task based on the AI model.

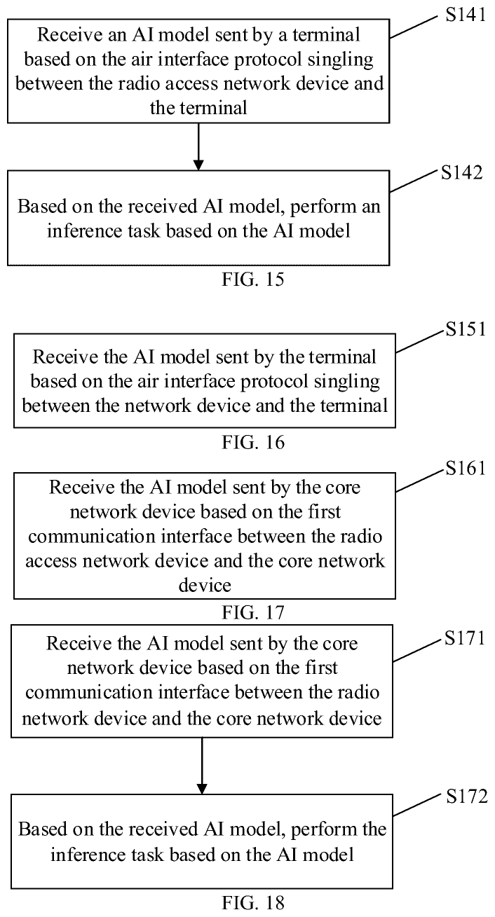

FIG. 15 is a flowchart of a method for a radio access network device to perform an inference task according to an example embodiment. As shown in FIG. 15, the method includes the following steps.

In step S141, based on air interface protocol signaling between the radio access network device and a terminal, an AI model sent by the terminal is received.

In step S142, based on the received AI model, an AI inference task based on the AI model is performed.

In a feasible implementation, direct AI model transfer may be achieved through air interface protocol signaling between the radio access network device and the terminal.

FIG. 16 is a flowchart of a method for receiving an AI model sent by a terminal according to an example embodiment. As shown in FIG. 16, the method includes the following step.

In step S151, based on the air interface protocol signaling between the network device and the terminal, the AI model sent by the terminal is received.

In the method provided in the embodiment of the present disclosure, the terminal directly transfers the AI model to the radio access network device according to the air interface protocol signaling between the radio access network device and the terminal.

In an embodiment of the present disclosure, the air interface protocol signaling includes at least one of: physical layer signaling, logical access layer MAC signaling, Radio Resource Control (RRC) signaling, or air interface user plane signaling.

In another feasible implementation, the AI model sent by the terminal may be forwarded to the radio access network device through a core network device to achieve indirect AI model transfer.

FIG. 17 is a flowchart of another method for receiving an AI model sent by a terminal according to an example embodiment. As shown in FIG. 17, the method includes the following steps.

In step S161, the AI model sent by a core network device based on a first communication interface between a radio access network device and the core network device is received.

The AI model is sent by a terminal to the core network device based on a second communication interface between the terminal and the core network device.

In the method provided by the embodiment of the present disclosure, the AI model sent by the radio access network device may be received by the core network device, and the core network device forwards the received AI model to the terminal.

For example, in a case where the terminal receives the AI model sent by the core network device, the terminal can perform an inference task based on the AI model.

FIG. 18 is a flowchart of a method for an AI inference node to perform an inference task based on an AI model according to an example embodiment. As shown in FIG. 18, the method includes the following steps.

In step S171, the AI model sent by a core network device based on a first communication interface between a radio access network device and the core network device is received.

The AI model is sent by a terminal to the core network device based on a second communication interface between the terminal and the core network device.

In step S172, based on the received AI model, an inference task is performed based on the AI model.

The core network device involved in the above embodiments may be, for example, an OAM core network device or a NWDAF core network device.

In an embodiment of the present disclosure, the core network device includes an AMF and a UPF. Accordingly, the first communication interface between the radio access network device and the core network device may include, for example, a dedicated communication interface between the radio access network device and the UPF, or a dedicated communication interface between the radio access network device and the AMF.

In an implementation, the AI model transfer between the radio access network device and the core network device may be performed through a dedicated communication interface between the radio access network device and the AMF. On this basis, the core network device accordingly uses a NAS signaling interface to perform AI model transfer with the terminal.

In another implementation, the AI model transfer between the radio access network device and the core network device may be performed through a dedicated communication interface between the radio access network device and the UPF. On this basis, the core network device accordingly uses an upload UP protocol interface to perform the AI model transfer with the terminal.

Based on the same concept, the present disclosure provides another communication method based on an AI model. The method is applied to a core network device which is used to interact with the AI provider node and the AI inference node involved in any one of the above embodiments to complete the forwarding of the AI model. If there are any unclear points in the following embodiments, reference may be made to any one of the above embodiments. Similarly, if there are any unclear points in the above embodiments, reference may be made to any one of the following embodiments.

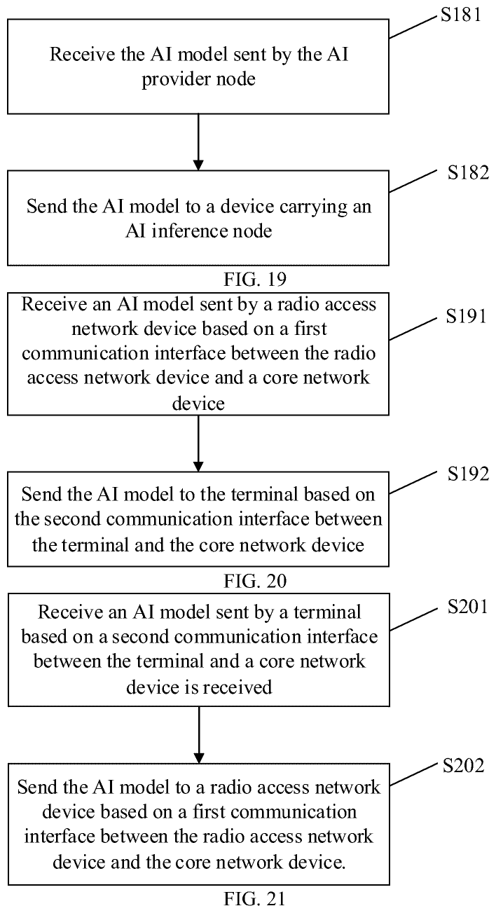

FIG. 19 is a flowchart of a method based on an artificial intelligence model according to an example embodiment. As shown in FIG. 19, the method includes the following steps.

In step S181, an AI model sent by an AI provider node is received.

In step S182, the AI model is sent to a device carrying the AI inference node.

The AI provider node and the AI inference node may be located at different devices of a radio access network device and a terminal, and the AI model is sent by a device carrying the AI provider node.

In the embodiment of the present disclosure, for the case where the AI provider node and the AI inference node are located at different devices in the radio access network device and the terminal, the core network device can receive the AI model sent by the device carrying the AI provider node, and forward the AI model to the device carrying the AI inference node, so that the device carrying the AI inference node performs an inference task based on the AI model.

In an embodiment of the present disclosure, the AI provider node and the AI inference node are located at different devices in the radio access network device and the terminal. For example, the AI provider node may be located at the radio access network device, and the AI inference node may be located at the terminal. In the case where the AI provider node is located at the radio access network device and the AI inference node is located at the terminal, the AI model sent by the radio access network device may be forwarded to the terminal through the core network device.

FIG. 20 is a flowchart of another method based on artificial intelligence model according to an example embodiment. As shown in FIG. 20, the method includes the following steps.

In step S191, an AI model sent by a radio access network device based on a first communication interface between the radio access network device and a core network device is received.

In step S192, the AI model is sent to a terminal based on a second communication interface between the terminal and the core network device.

In addition, the AI provider node may be located at the terminal, and the AI inference node may be located at the radio access network device. In the case where the AI provider node is located at the terminal and the AI inference node is located at the radio access network device, the AI model sent by the terminal may be forwarded to the radio access network device through the core network device.

FIG. 21 is a flowchart of another method based on an artificial intelligence model according to an example embodiment. As shown in FIG. 21, the method includes the following steps.

In step S201, an AI model sent by a terminal based on a second communication interface between the terminal and a core network device is received.

In step S202, the AI model is sent to a radio access network device based on a first communication interface between the radio access network device and the core network device.

In an embodiment of the present disclosure, the core network device includes an AMF and a UPF. Accordingly, the first communication interface between the radio access network device and the core network device may include, for example, a dedicated communication interface between the radio access network device and the UPF, and a dedicated communication interface between the radio access network device and the UPF.

In an implementation, the AI model transfer between the radio access network device and the core network device may be performed through a dedicated communication interface between the radio access network device and the AMF. On this basis, the core network device accordingly uses an NAS signaling interface to perform the AI model transfer with the terminal.

In another implementation, the AI model transfer between the radio access network device and the core network device may be performed through a dedicated communication interface between the radio access network device and the UPF. On this basis, the core network device accordingly uses an upload UP protocol interface to perform the AI model transfer with the terminal.

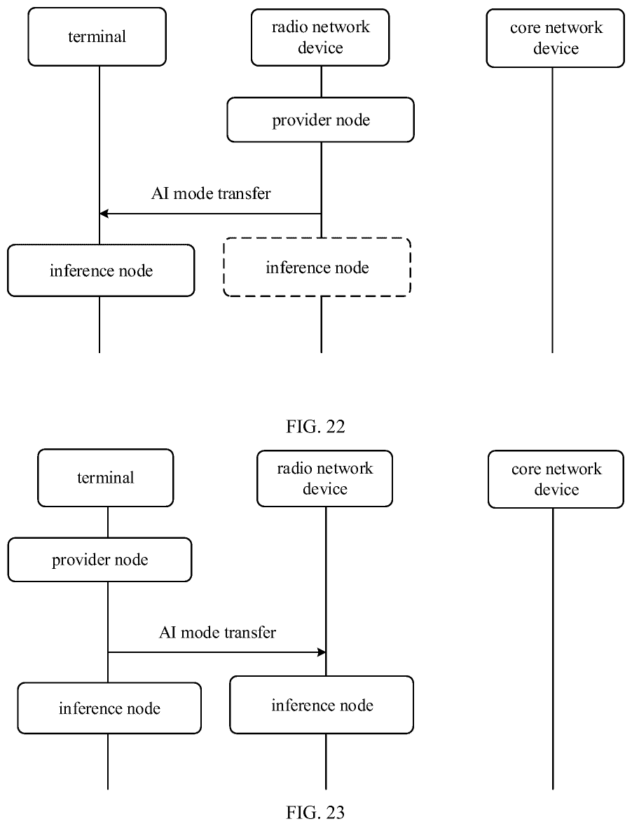

FIG. 22 is a schematic diagram of a radio access network device transferring an AI model directly to a terminal. For example, as shown in FIG. 22, an AI provider node is located at the radio access network device, and an AI inference node may be located at the radio access network device or a terminal. The radio access network device may train and/or fine-tune the AI model to provide a trained AI model at the AI provider node. In this case, if the AI inference node is located at the radio access network device, the radio access network directly performs an inference task based on the AI model. If the AI inference node is located at the terminal, the radio access network device carries the AI model through air interface protocol signaling between the radio access network device and the terminal, and then sends the AI model to the terminal by sending the air interface protocol signaling. In this way, the terminal can perform an inference task according to the received AI model.

FIG. 23 is a schematic diagram of a terminal transferring an AI model directly to a radio access network device. For example, as shown in FIG. 23, an AI provider node is located at the terminal, and an AI inference node may be located at a radio access network device or the terminal. The terminal may train and/or fine-tune the AI model to provide a trained AI model at the AI provider node. In this case, if the AI inference node is located at the terminal, the terminal directly performs an inference task based on the AI model. If the AI inference node is located at the radio access network device, the terminal carries the AI model through air interface protocol signaling between the terminal and the radio access network device, and then sends the AI model to the radio access network device by sending the air interface protocol signaling. In this way, the radio access network device can perform an inference task according to the received AI model.

For example, for the above-mentioned method of transferring the AI model by the air interface protocol signaling, the air interface protocol signaling used includes but is not limited to at least one of: physical layer signaling, MAC signaling, RRC signaling or air interface user plane signaling. The air interface user plane signaling may be, for example, Data Radio Bearer (DRB) signaling supported by an air interface user plane function. Taking DRB signaling as an example, for the AI model transfer, the present disclosure may configure specific DRB signaling dedicated to the transfer of the AI model, so that the signaling can carry the AI model. On this basis, the transfer of the AI model can be completed between the radio access network device and the terminal by transferring DRB signaling.

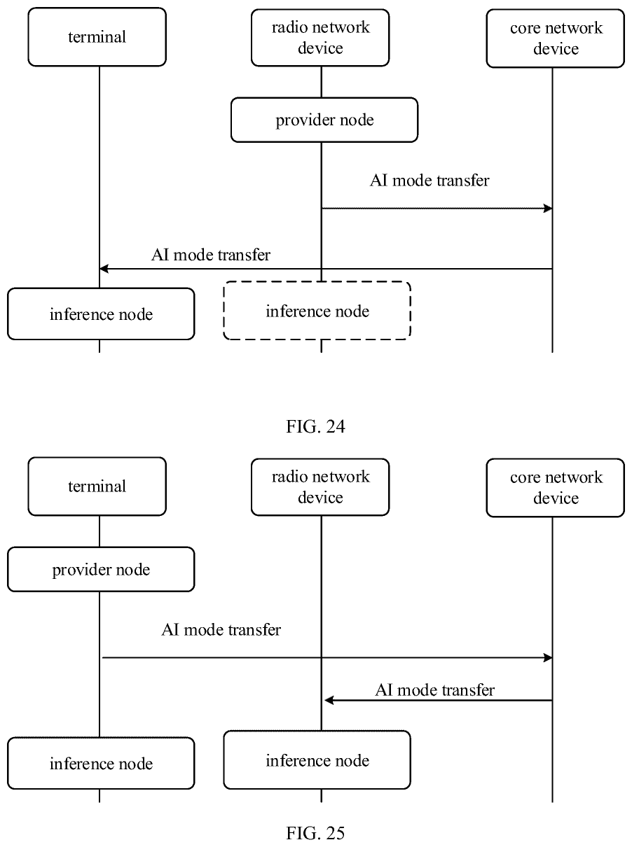

FIG. 24 is a schematic diagram of indirect AI model transfer between a radio access network device and a terminal through a core network device. For example, as shown in FIG. 24, an AI provider node is located at the radio access network device, and the AI inference node may be located at the radio access network device or the terminal. The radio access network device may train and/or fine-tune the AI model to provide a trained AI model at the AI provider node. In this case, if the AI inference node is located at the radio access network device, the radio access network device directly performs an inference task based on the AI model. If the AI inference node is located at the terminal, the radio access network device transfers the AI model through a second communication interface between the radio access network device and the core network device, so that the core network device obtains the AI model. On this basis, the core network device may transfer the AI model through a first communication interface between the terminal and the core network device, so that the terminal obtains the AI model and further performs an inference task based on the AI model.

FIG. 25 is a schematic diagram of another indirect AI model transfer between a radio access network device and a terminal through a core network device. For example, as shown in FIG. 25, an AI provider node is located at the radio access network device, and an AI inference node may be located at the radio access network device or the terminal. The terminal may train and/or fine-tune the AI model to provide a trained AI model at the AI provider node. In this case, if the AI inference node is located at the terminal, the terminal directly performs the inference task based on the AI model. If the AI inference node is located at the radio access network device, the terminal transfers the AI model through a first communication interface between the terminal and the core network device, so that the core network device obtains the AI model. On this basis, the core network device can transfer the AI model through a second communication interface between the radio access network device and the core network device, so that the radio access network device obtains the AI model, and further performs an inference task based on the AI model.

For the scenario where the AI provider node and the AI inference node are located at different communication devices, the methods provided by the embodiments of the present disclosure provide feasible ways for AI model transfer between different communication devices, and define the transfer rule(s) of the AI model. In addition, by rationally utilizing respective communication device(s) in the communication system, direct AI model transfer and indirect AI model transfer are realized between the radio access network and the terminal, and thus the transfer method of the AI model is more flexible.

It should be noted that those skilled in the art can understand that the various implementations/embodiments involved in the embodiments of the present disclosure can be used in conjunction with the aforementioned embodiments or can be used independently. Whether used independently or in conjunction with the aforementioned embodiments, the implementation principle is similar. In the implementations of the present disclosure, some embodiments are described in terms of implementations used together. Of course, those skilled in the art can understand that such examples are not limitations of the embodiments of the present disclosure.

Based on the same concept, an embodiment of the present disclosure also provides a communication apparatus based on an Artificial Intelligence (AI) model.

It is understandable that the communication apparatus based on the Artificial Intelligence (AI) model provided by the embodiment of the present disclosure is configured to implement the above function(s) and includes hardware structure(s) and/or software module(s) corresponding to the execution of respective function(s). In combination with the units and algorithm steps of respective examples disclosed in the embodiments of the present disclosure, the embodiments of the present disclosure can be implemented in the form of hardware or a combination of hardware and computer software. Whether a function is implemented in the form of hardware or computer software driving hardware depends on the specific application and design constraints of the technical solutions. Those skilled in the art may use different methods to implement the described function(s) for each specific application, but such implementation should not be considered to go beyond the scope of the technical solutions of the embodiments of the present disclosure.

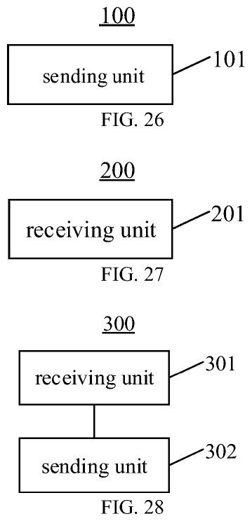

FIG. 26 is a block diagram of a communication apparatus based on an Artificial Intelligence (AI) model according to an example embodiment. Referring to FIG. 26, the apparatus 100 includes a sending unit 101.

The sending unit 101 is configured to send the AI model to an AI inference node.

In an implementation, the AI provider node is located at a radio access network device. The sending unit sends the AI model to the AI inference node in the following manner: sending the AI model to a terminal.

In an implementation, the sending unit 101 sends the AI model to the terminal in the following manner: based on air interface protocol signaling between the radio access network device and the terminal, sending the AI model to the terminal.

In an implementation, the sending unit 101 sends the AI model to the terminal in the following manner: sending, by the radio access network device, the AI model to a core network device through a first communication interface. The AI model is sent to the terminal by the core network device through a second communication interface.

In an implementation, the AI provider node is located at a terminal. The sending unit 101 sends the AI model to the AI inference node in the following manner: sending the AI model to a radio access network device.

In an implementation, the sending unit 101 sends the AI model to the radio access network device in the following manner: based on air interface protocol signaling between the network device and the terminal, sending the AI model to the radio access network device.

In an implementation, the sending unit 101 sends the AI model to the radio access network device in the following manner: sending, by the terminal, the AI model to a core network device through a second communication interface. The AI model is sent to the radio access network device by the core network device through a first communication interface.

In an implementation, the air interface protocol signaling includes at least one of: physical layer signaling, logical access layer MAC signaling, Radio Resource Control (RRC) signaling, or air interface user plane signaling.

In an implementation, the first communication interface includes a dedicated communication interface between the radio access network device and an AMF, and the second communication interface includes a NAS signaling interface; or, the first communication interface includes a dedicated communication interface between the radio access network device and an UPF, and the second communication interface includes a UP protocol interface.

FIG. 27 is a block diagram of a communication apparatus based on an Artificial Intelligence (AI) model according to an example embodiment. Referring to FIG. 27, the apparatus 200 includes a receiving unit 201.

The receiving unit 201 is configured to receive an AI model sent by an AI provider node.

In an implementation, the AI inference node is located at the terminal. The receiving unit 201 receives the AI model sent by the AI provider node in the following manner: receiving the AI model sent by a radio access network device.

In an implementation, the receiving unit 201 receives the AI model sent by the radio access network device in the following manner: based on air interface protocol signaling between the radio access network device and the terminal, receiving the AI model sent by the radio access network device.

In an implementation, the receiving unit 201 receives the AI model sent by the radio access network device in the following manner: receiving the AI model sent by a core network device based on a second communication interface between the terminal and the core network device, where the AI model is sent by the radio access network device to the core network device based on a first communication interface between the radio access network device and the core network device.

In an implementation, the AI inference node is located at the radio access network device. The receiving unit 201 receives the AI model sent by the AI provider node in the following manner: receiving the AI model sent by the terminal.

In an implementation, the receiving unit 201 receives the AI model sent by the terminal in the following manner: based on air interface protocol signaling between the radio access network device and the terminal, receiving the AI model sent by the terminal.

In an implementation, the receiving unit 201 receives the AI model sent by the terminal in the following manner: receiving the AI model sent by the core network device based on the first communication interface between the radio access network device and the core network device, where the AI model is sent by the terminal to the core network device based on the second communication interface between the terminal and the core network device.

In an implementation, the air interface protocol signaling includes at least one of: physical layer signaling, logical access layer MAC signaling, Radio Resource Control (RRC) signaling, or air interface user plane signaling.

In an implementation, the first communication interface includes a dedicated communication interface between the radio access network device and an AMF, and the second communication interface includes a NAS signaling interface; or, the first communication interface includes a dedicated communication interface between the radio access network device and an UPF, and the second communication interface includes a UP protocol interface.

FIG. 28 is a block diagram of a communication apparatus based on an Artificial Intelligence (AI) model according to an example embodiment. Referring to FIG. 28, the apparatus 300 includes a receiving unit 301 and a sending unit 302.

The receiving unit 301 is configured to receive the AI model sent by an AI provider node. The sending unit 302 is configured to send the AI model to an AI inference node.

In an implementation, the receiving unit 301 receives the AI model sent by the AI provider node in the following manner: receiving the AI model sent by a radio access network device based on a first communication interface between the radio access network device and the core network device. The sending unit 302 sends the AI model to the AI inference node in the following manner: sending the AI model to a terminal based on a second communication interface between the terminal and the core network device.

In an implementation, the receiving unit 301 receives the AI model sent by the AI provider node in the following manner: receiving the AI model sent by the terminal based on the second communication interface between the terminal and the core network device. The sending unit 302 sends the AI model to the AI inference node in the following manner: sending the AI model to the radio access network device based on the first communication interface between the radio access network device and the core network device.

In an implementation, the first communication interface includes a dedicated communication interface between the radio access network device and an AMF, and the second communication interface includes a NAS signaling interface; or, the first communication interface includes a dedicated communication interface between the radio access network device and an UPF, and the second communication interface includes a UP protocol interface.

Regarding the apparatuses in the above embodiments, the specific manner in which each module performs operation(s) has been described in detail in the embodiments of the methods, and will not be elaborated here.

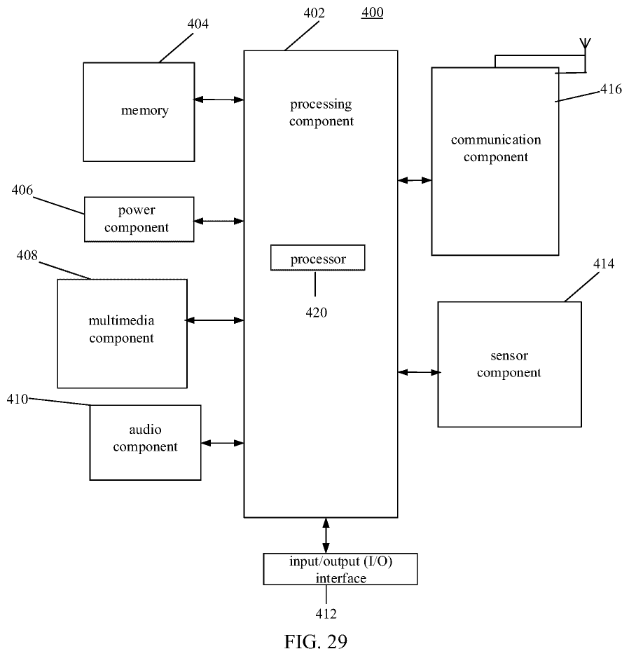

FIG. 29 is a block diagram of an apparatus 400 for a communication based on an Artificial Intelligence (AI) model according to an example embodiment. For example, the apparatus 400 may be a mobile phone, a computer, a digital broadcast terminal, a messaging device, a gaming console, a tablet, a medical device, exercise equipment, a personal digital assistant, and the like.

Referring to FIG. 29, the apparatus 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the apparatus 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the apparatus 400. Examples of such data include instructions for any applications or methods operated on the apparatus 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the apparatus 400. The power component 406 may include a power management system, one or more power sources, and any other components associated with the generation, management, and distribution of power in the apparatus 400.

The multimedia component 408 includes a screen providing an output interface between the apparatus 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera and/or a rear camera. The front camera and the rear camera may receive an external multimedia datum while the apparatus 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (“MIC”) configured to receive an external audio signal when the apparatus 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the apparatus 400. For instance, the sensor component 414 may detect an open/closed status of the apparatus 400, relative positioning of components, e.g., the display and the keypad, of the apparatus 400, a change in position of the apparatus 400 or a component of the apparatus 400, a presence or absence of user contact with the apparatus 400, an orientation or an acceleration/deceleration of the apparatus 400, and a change in temperature of the apparatus 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the apparatus 400 and other devices. The apparatus 400 can access a wireless network based on a communication standard, such as WiFi, 2G, or 3G, or a combination thereof. In one example embodiment, the communication component 416 receives a broadcast signal or broadcast associated information from an external broadcast management system via a broadcast channel. In one example embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 404 including instructions executable by the processor 420 in the apparatus 400, for performing the above-described methods. For example, the non-transitory computer-readable storage medium may be a ROM, a Random Access Memory (RAM), a CD-ROM, a magnetic tape, a floppy disc, an optical data storage device, and the like.

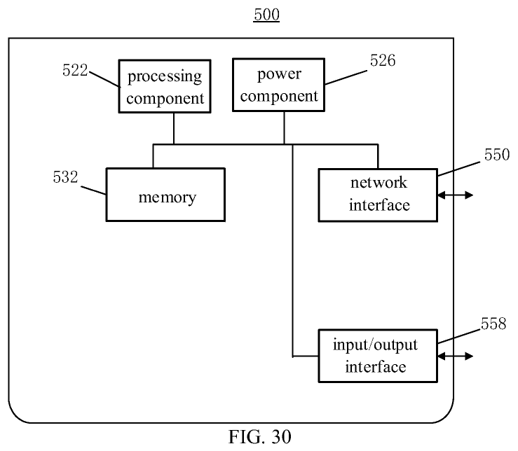

FIG. 30 is a block diagram of an apparatus 500 for a communication based on an Artificial Intelligence (AI) model according to an example embodiment. For example, the apparatus 500 may be provided as a server. Referring to FIG. 30, the apparatus 500 includes a processing component 522 that further includes one or more processors, and memory resources represented by a memory 532 for storing instructions executable by the processing component 522, such as application programs. The application programs stored in the memory 532 may include one or more modules each corresponding to a set of instructions. Further, the processing component 522 is configured to execute the instructions to perform the above methods.

The apparatus 500 may also include a power component 526 configured to perform power management of the apparatus 500, wired or wireless network interface(s) 550 configured to connect the apparatus 500 to a network, and an input/output (I/O) interface 558. The apparatus 500 may operate based on an operating system stored in the memory 932, such as Windows Server™, Mac OS XTM, Unix™, Linux™, FreeBSD™, or the like.

In an example embodiment, a non-transitory computer-readable storage medium including instructions is further provided, for example the memory 532 including instructions, and the instructions may be executed by the processing component 522 of the apparatus 500 to perform the above methods. For example, the non-transitory computer-readable storage medium may be a ROM, a Random Access Memory (RAM), a CD-ROM, a magnetic tape, a floppy disk, an optical data storage device, etc.

It can be further understood that in the present disclosure, “plurality” refers to two or more than two, and other quantifiers are similar. The expression “and/or” describes an association relationship of associated objects, indicating that three relationships may exist. For example, A and/or B may represent: A exists alone, A and B exist at the same time, and B exists alone. The character “/” generally indicates that associated objects before and after the character are in an “or” relationship. The singular forms “a/an”, “said” and “the” are also intended to include a plural form, unless the context clearly indicates other meanings.

It can be further understood that the meaning of words such as “in response to”, “if” or “in a case” involved in the present disclosure depends on the context and the actual usage scenario. For example, the word “in response to” used herein may be interpreted as “when perform a communication based on an Artificial Intelligence (AI) model” or “in a case where the communication is performed based on an Artificial Intelligence (AI) model” or “if”.

It can be further understood that the terms “first”, “second”, etc. are used to describe various information, but such information should not be limited to these terms. These terms are only used to distinguish the same type of information from each other, and do not indicate a specific order or degree of importance. In fact, the expressions “first”, “second”, etc. can be used interchangeably. For example, without departing from the scope of the present disclosure, first information may also be referred to as second information, and similarly, second information may also be referred to as the first information.

It can be further understood that, although the operations are described in a specific order in the drawings in the embodiments of the present disclosure, it should not be understood as requiring the operations to be performed in the specific order or in a serial order shown, or requiring the execution of all the operations shown to obtain the desired result(s). In certain environments, multitasking and parallel processing may be advantageous.

Further example embodiments are listed as follows.

According to an embodiment of the present disclosure, there is provided a communication method based on an Artificial Intelligence (AI) model. The method includes:
sending the AI model to an AI inference node.

In an implementation, the AI provider node is located at a radio access network device; sending the AI model to the AI inference node includes: sending the AI model to a terminal.

In an implementation, sending the AI model to the terminal includes: based on air interface protocol signaling between the radio access network device and the terminal, sending he AI model to the terminal.

In an implementation, sending the AI model to the terminal includes: sending, by the radio access network device, the AI model to a core network device through a first communication interface; wherein the AI model is sent by the core network device to the terminal through a second communication interface.

In an implementation, the AI provider node is located at a terminal; sending the AI model to the AI inference node includes: sending the AI model to a radio access network device.

In an implementation, sending the AI model to the radio access network device includes: based on air interface protocol signaling between the radio access network device and the terminal, sending the AI model to the radio access network device.

In an implementation, sending the AI model to the radio access network device includes: sending, by the terminal, the AI model to the core network device through a second communication interface; wherein the AI model is sent by the core network device to the radio access network device through a first communication interface.

In an implementation, the air interface protocol signaling includes at least one of: physical layer signaling; logical access layer MAC signaling; Radio Resource Control (RRC) signaling; or air interface user plane signaling.

In an implementation, the first communication interface includes a dedicated communication interface between the radio access network device and an AMF, and the second communication interface includes a NAS signaling interface; or wherein the first communication interface includes a dedicated communication interface between the radio access network device and a UPF, and the second communication interface includes a UP protocol interface.

According to an embodiment of the present disclosure, there is provided a communication method based on an Artificial Intelligence (AI) model. The method includes: receiving the AI model sent by an AI provider node.

In an implementation, the AI inference node is located at the terminal; receiving the AI model sent by the AI provider node includes: receiving the AI model sent by a radio access network device.

In an implementation, receiving the AI model sent by the radio access network device includes: based on air interface protocol signaling between the radio access network device and a terminal, receiving the AI model sent by the radio access network device.

In an implementation, receiving the AI model sent by the radio access network device includes: receiving the AI model sent by a core network device based on a second communication interface between the terminal and the core network device, wherein the AI model is sent to the core network device by the radio access network device based on a first communication interface between the radio access network device and the core network device.

In an implementation, the AI inference node is located at a radio access network device; receiving the AI model sent by the AI provider node includes: receiving the AI model sent by a terminal.

In an implementation, receiving the AI model sent by the terminal includes: based on the air interface protocol signaling between the radio access network device and the terminal, receiving the AI model sent by the terminal.

In an implementation, receiving the AI model sent by the terminal includes: receiving the AI model sent by a core network device based on a first communication interface between the radio access network device and the core network device, wherein the AI model is sent by the terminal to the core network device based on a second communication interface between the terminal and the core network device.

In an implementation, the air interface protocol signaling includes at least one of: physical layer signaling; logical access layer MAC signaling; Radio Resource Control (RRC) signaling; or air interface user plane signaling.

In an implementation, the first communication interface includes a dedicated communication interface between the radio access network device and an AMF, and the second communication interface includes a NAS signaling interface; or wherein the first communication interface includes a dedicated communication interface between the radio access network device and a UPF, and the second communication interface includes a UP protocol interface.

According to an embodiment of the present disclosure, there is provided a communication method based on an Artificial Intelligence (AI) model. The method includes: receiving the AI model sent by an AI provider node; and sending the AI model to an AI inference node.

In an implementation, receiving the AI model sent by the AI provider node includes: receiving the AI model sent by the radio access network device based on a first communication interface between the radio access network device and the core network device; sending the AI model to the AI inference node includes: sending the AI model to the terminal based on a second communication interface between the terminal and the core network device.

In an implementation, receiving the AI model sent by the AI provider node includes: receiving the AI model sent by a terminal based on a second communication interface between the terminal and the core network device; sending the AI model to the AI inference node includes: sending the AI model to a radio access network device based on a first communication interface between the radio access network device and the core network device.

In an implementation, the first communication interface includes a dedicated communication interface between the radio access network device and an AMF, and the second communication interface includes a NAS signaling interface; or wherein the first communication interface includes a dedicated communication interface between the radio access network device and a UPF, and the second communication interface includes a UP protocol interface.

According to a fourth aspect of an embodiment of the present disclosure, there is provided a communication apparatus based on an Artificial Intelligence (AI) model. The apparatus includes: a sending unit configured to send the AI model to an AI inference node.

In an implementation, the AI provider node is located at a radio access network device; the sending unit is configured to: send the AI model to the terminal.

In an implementation, the sending unit is configured to: based on air interface protocol signaling between the radio access network device and the terminal, send the AI model to the terminal.

In an implementation, the sending unit is configured to: send the AI model to a core network device through a first communication interface; wherein the AI model is sent by the core network device to the terminal through a second communication interface.

In an implementation, the AI provider node is located at a terminal; the sending unit is configured to: send the AI model to a radio access network device.

In an implementation, the sending unit is configured to: based on air interface protocol signaling between the radio access network device and the terminal, send the AI model to the radio access network device.

In an implementation, the sending unit is configured to: send the AI model to the core network device through a second communication interface; wherein the AI model is sent by the core network device to the radio access network device through a first communication interface.

In an implementation, the air interface protocol signaling includes at least one of: physical layer signaling; logical access layer MAC signaling; Radio Resource Control (RRC) signaling; or air interface user plane signaling.

In an implementation, the first communication interface includes a dedicated communication interface between the radio access network device and an AMF, and the second communication interface includes a NAS signaling interface; or the first communication interface includes a dedicated communication interface between the radio access network device and a UPF, and the second communication interface includes a UP protocol interface.

According to an embodiment of the present disclosure, there is provided a communication apparatus based on an Artificial Intelligence (AI) model. The apparatus includes: a receiving unit configured to receive the AI model sent by an AI provider node.

In an implementation, the AI inference node is located at the terminal; the receiving unit is configured to: receive the AI model sent by the radio access network device.

In an implementation, the receiving unit is configured to: based on air interface protocol signaling between the radio access network device and the terminal, receive the AI model sent by the radio access network device.

In an implementation, the receiving unit is configured to: receive the AI model sent by a core network device based on a second communication interface between the terminal and the core network device, wherein the AI model is sent by the radio access network device to the core network device based on a first communication interface between the radio access network device and the core network device.

In an implementation, the AI inference node is located at the radio access network device; the receiving unit is configured to: receive the AI model sent by the terminal.

In an implementation, the receiving unit is configured to: based on the air interface protocol signaling between the radio access network device and the terminal, receive the AI model sent by the terminal.

In an implementation, the receiving unit is configured to: receive the AI model sent by a core network device based on a first communication interface between the radio access network device and the core network device, wherein the AI model is sent to by the terminal to the core network device based on a second communication interface between the terminal and the core network device.

In an implementation, the air interface protocol signaling includes at least one of: physical layer signaling; logical access layer MAC signaling; Radio Resource Control (RRC) signaling; or air interface user plane signaling.

In an implementation, the first communication interface includes a dedicated communication interface between the radio access network device and an AMF, and the second communication interface includes a NAS signaling interface; or the first communication interface includes a dedicated communication interface between the radio access network device and a UPF, and the second communication interface includes a UP protocol interface.

According to an embodiment of the present disclosure, there is provided a communication apparatus based on an Artificial Intelligence (AI) model. The apparatus includes: a receiving unit configured to receive the AI model sent by an AI provider node; and a sending unit configured to send the AI model to an AI inference node.

In an implementation, the receiving unit is configured to: receive the AI model sent by the radio access network device based on a first communication interface between the radio access network device and the core network device; the sending unit is configured to: send the AI model to the terminal based on a second communication interface between the terminal and the core network device.

In an implementation, the receiving unit is configured to: receive the AI model sent by the terminal based on a second communication interface between the terminal and the core network device; the sending unit is configured to: send the AI model to the radio access network device based on a first communication interface between the radio access network device and the core network device.

In an implementation, the first communication interface includes a dedicated communication interface between the radio access network device and an AMF, and the second communication interface includes a NAS signaling interface; or the first communication interface includes a dedicated communication interface between the radio access network device and a UPF, and the second communication interface includes a UP protocol interface.

Those skilled in the art will readily appreciate other embodiments of the present disclosure after considering the description and practicing the invention disclosed herein. The present application is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the precise structures that have been described above and shown in the drawings, and that various modifications and changes may be made without departing from the scope of the present disclosure. The scope of the present disclosure is limited only by the scope of the appended claims.

1. A communication method based on an Artificial Intelligence (AI) model, wherein the method is applied to an AI provider node, and the method comprises:
sending the AI model to an AI inference node.

2. The method according to claim 1, wherein the AI provider node is located at a radio access network device;
wherein sending the AI model to the AI inference node comprises:
sending the AI model to a terminal.

3. The method according to claim 2, wherein sending the AI model to the terminal comprises:
based on air interface protocol signaling between the radio access network device and the terminal, sending he AI model to the terminal.

4. The method according to claim 2, wherein sending the AI model to the terminal comprises:
sending, by the radio access network device, the AI model to a core network device through a first communication interface;
wherein the AI model is sent by the core network device to the terminal through a second communication interface.

5. The method according to claim 1, wherein the AI provider node is located at a terminal;
wherein sending the AI model to the AI inference node comprises:
sending the AI model to a radio access network device.

6. The method according to claim 5, wherein sending the AI model to the radio access network device comprises:
based on air interface protocol signaling between the radio access network device and the terminal, sending the AI model to the radio access network device.

7. The method according to claim 5, wherein sending the AI model to the radio access network device comprises:
sending, by the terminal, the AI model to a core network device through a second communication interface;
wherein the AI model is sent by the core network device to the radio access network device through a first communication interface.

8. The method according to claim 3, wherein the air interface protocol signaling comprises at least one of:
physical layer signaling;
Medium Access Control (MAC) signaling;
Radio Resource Control (RRC) signaling; or air interface user plane signaling.

9. The method according to claim 4, wherein the first communication interface comprises a dedicated communication interface between the radio access network device and an Access and Mobility management Function (AMF), and the second communication interface comprises a Non-Access Stratum (NAS) signaling interface; or
wherein the first communication interface comprises a dedicated communication interface between the radio access network device and a User Plane Function (UPF), and the second communication interface comprises a User Plane (UP) protocol interface.

10. A communication method based on an Artificial Intelligence (AI) model, wherein the method is applied to an AI inference node, and the method comprises:
receiving the AI model sent by an AI provider node.

11. The method according to claim 10, wherein the AI inference node is located at a terminal;
wherein receiving the AI model sent by the AI provider node comprises:
receiving the AI model sent by a radio access network device.

12. The method according to claim 11, wherein receiving the AI model sent by the radio access network device comprises:
based on air interface protocol signaling between the radio access network device and a terminal, receiving the AI model sent by the radio access network device; or
wherein receiving the AI model sent by the radio access network device comprises:
receiving the AI model sent by a core network device based on a second communication interface between the terminal and the core network device, wherein the AI model is sent to the core network device by the radio access network device based on a first communication interface between the radio access network device and the core network device.

13. (canceled)

14. The method according to claim 10, wherein the AI inference node is located at a radio access network device;
wherein receiving the AI model sent by the AI provider node comprises:
receiving the AI model sent by a terminal.

15. The method according to claim 14, wherein receiving the AI model sent by the terminal comprises:
based on the air interface protocol signaling between the radio access network device and the terminal, receiving the AI model sent by the terminal; or
wherein receiving the AI model sent by the terminal comprises:
receiving the AI model sent by a core network device based on a first communication interface between the radio access network device and the core network device, wherein the AI model is sent by the terminal to the core network device based on a second communication interface between the terminal and the core network device.

16-18. (canceled)

19. A communication method based on an Artificial Intelligence (AI) model, wherein the method is applied to a core network device, and the method comprises:
receiving the AI model sent by an AI provider node; and
sending the AI model to an AI inference node.

20. The method according to claim 19, wherein receiving the AI model sent by the AI provider node comprises:
receiving the AI model sent by a radio access network device based on a first communication interface between the radio access network device and the core network device;
wherein sending the AI model to the AI inference node comprises: sending the AI model to a terminal based on a second communication interface between the terminal and the core network device.

21. The method according to claim 19, wherein receiving the AI model sent by the AI provider node comprises:
receiving the AI model sent by a terminal based on a second communication interface between the terminal and the core network device;
wherein sending the AI model to the AI inference node comprises: sending the AI model to a radio access network device based on a first communication interface between the radio access network device and the core network device.

22-45. (canceled)

46. A communication apparatus based on an Artificial Intelligence (AI) model, the apparatus comprising:
a processor; and
a memory configured to store instructions executable by the processor;
wherein the processor is configured to perform the method according to claim 1.

47-48. (canceled)

49. A non-transitory storage medium, wherein instructions are stored in the storage medium, and when the instructions in the storage medium are executed by a processor, the processor is caused to perform the communication method based on the Artificial Intelligence (AI) model according to claim 1.

50-51. (canceled)
